(19) United States
(12) Patent Application Publication
(10) Pub. No.: US 2016/0207689 A1
(43) Pub. Date: Jul. 21, 2016

(54) FLEXIBLE PACKAGE WITH VENT FOR COOKING A FOODSTUFF THEREIN

(71) Applicant: Fres-co System USA, Inc., Telford, PA (US)

(72) Inventor: Menaka Hemamali Abeygunawardena, Ambler, PA (US)

(21) Appl. No.: 14/994,426

(22) Filed: Jan. 13, 2016

Related U.S. Application Data
(60) Provisional application No. 62/105,286, filed on Jan. 20, 2015.

(51) Int. Cl. B65D 81/34; B65D 79/00; B65D 75/58; B65D 85/72

(52) U.S. Cl. CPC B65D 81/3461; A23L 1/32; B65D 85/72; B65D 79/005; B65D 75/5805

(57) ABSTRACT

Disclosed is a flexible package holding a foodstuff to be cooked therein. The package includes an interior space in which the foodstuff is located and a panel from which a fin projects. The fin includes at least one vent formed by a peelable interface having a first end in communication with the interior space and a second end in communication with the ambient atmosphere outside of the package. The peelable interface forms an openable passageway tapering from the first end to the second end and opens in response to steam produced within the package when the foodstuff is cooked, whereupon the steam can exit the package through the passageway.

### CROSS-REFERENCE TO RELATED APPLICATIONS

This utility application claims the benefit under 35 U.S.C. §119(e) of Provisional Application Ser. No. 62/105,286, filed on Jan. 20, 2015, entitled Flexible Package with a Vent for Cooking a Foodstuff Therein. The entire disclosure of this provisional application is incorporated by reference herein.

### BACKGROUND OF THE INVENTION

This invention relates to flexible packages and more particularly to flexible packages containing foodstuffs to be cooked herein.

Various types of flexible packages have been disclosed in the patent literature and many are commercially available for cooking foodstuffs in a microwave oven. The foodstuff may be uncooked, such as frozen foods, popcorn, and the like. However, there has been no commercially viable flexible package for cooking a liquid-like foodstuff, such as an uncooked egg, in the package to produce a cooked egg. Thus, the need exists for such a package. The subject invention addresses that need.

### SUMMARY OF THE INVENTION

The subject invention is directed to flexible packages for holding a foodstuff, e.g., an uncooked, scrambled egg, to be cooked therein. The packages of this invention are formed of a flexible sheet material and comprise a bottom panel, a top panel, and an interior space therebetween in which the foodstuff to be cooked can be located. The top panel comprises an elongated upstanding fin having at least one vent therein. The upstanding fin is formed by edge portions of the top panel. The at least one vent comprises respective portions of the edge portions releasably secured together by a peelable interface having a first end in communication with the interior space and a second end in communication with the ambient atmosphere outside of the package. The peelable interface forms an openable passageway tapering from the first end to the second end and is configured to open in response to the production of steam within the package when the foodstuff is cooked therein, whereupon the steam can exit the package through the passageway.

In accordance with one aspect of this invention the size of the passageway at the first end is sufficiently large to enable steam generated in the interior space by the cooking of the foodstuff to initiate the opening of the passageway and with the size of the passageway at the second end being sufficiently small to enable the steam to exit the package through the passageway, while preventing any of the foodstuff from exiting the package through the passageway.

In accordance with another aspect of this invention at least one vent is configured and disposed along the upstanding fin to ensure even and thorough cooking of the foodstuff within the package.

In accordance with another aspect of this invention the package comprises a flat pouch and with the bottom wall being configured to be disposed on a surface in an oven such that the upstanding fin is exposed to enable steam to readily vent through the passageway.

In accordance with another aspect of this invention the interior space is of sufficient volume to accommodate the volume of the foodstuff after it has been cooked, without any portion of the cooked foodstuff gaining accidental egress from said package.

In accordance with another aspect of this invention the package includes a readily openable portion to enable access to the cooked foodstuff.

Still another aspect of this invention entails the combination of the package and the foodstuff.

### DESCRIPTION OF THE DRAWING

FIG. 1 is an isometric view of a first preferred exemplary embodiment of a flexible package constructed in accordance with this invention from a web or sheet of flexible material;

FIG. 2 is an enlarged end view taken along line 2-2 of FIG. 1;

FIG. 3A is a top plan view of a precursor web or sheet of flexible material for forming the package, shown prior to folding and sealing the web or sheet into the package shown in FIG. 1;

FIG. 3B is a greatly enlarged sectional view, not to scale, taken along line 3B-3B of FIG. 3A;

FIG. 4 is an isometric view of a second preferred exemplary embodiment of a flexible package constructed in accordance with this invention;

FIG. 5 is an enlarged end view taken along line 5-5 of FIG. 4;

FIG. 6 is a top plan view of the precursor web or sheet of flexible material for forming the package of FIG. 4 prior to the folding and sealing the web or sheet into that package;

FIG. 7 is an isometric view of a third preferred exemplary embodiment of a flexible package constructed in accordance with this invention;

FIG. 8 is an enlarged end view taken along line 8-8 of FIG. 7; and

FIG. 9 is a top plan view of the precursor web or sheet of flexible material for forming the package of FIG. 7 prior to the folding and sealing the web or sheet into that package.

### DETAILED DESCRIPTION OF THE PREFERRED EMBODIMENT

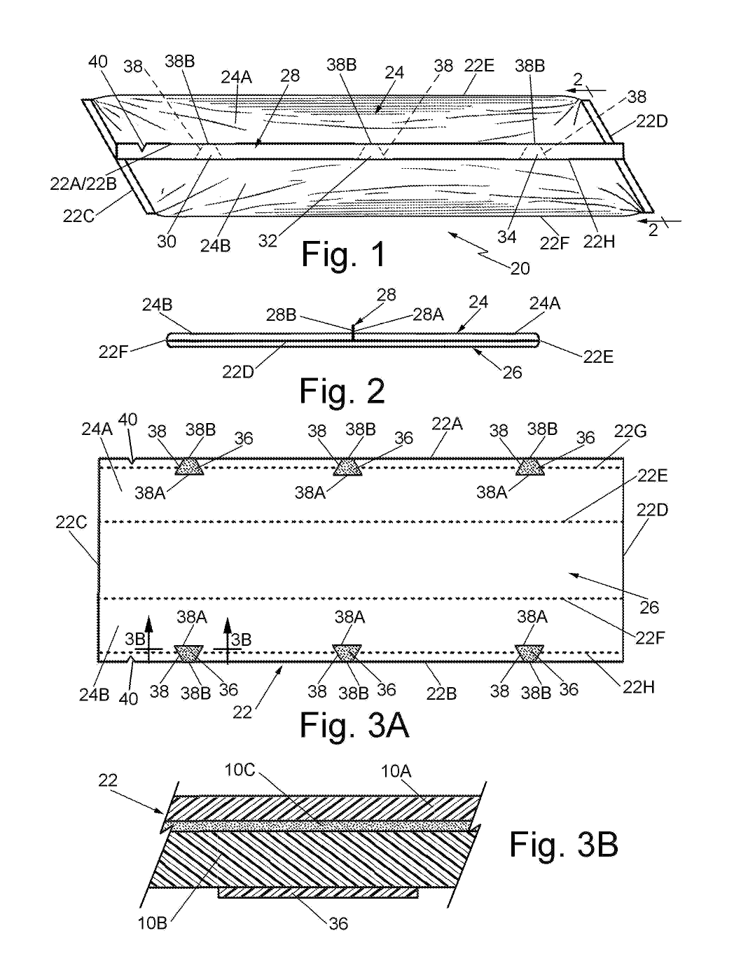

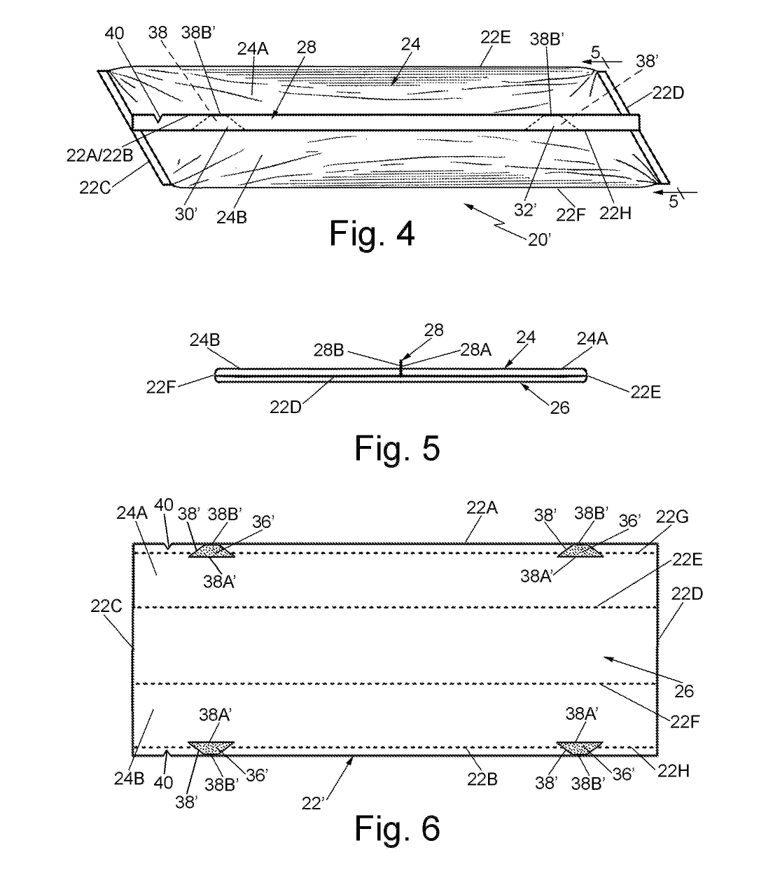

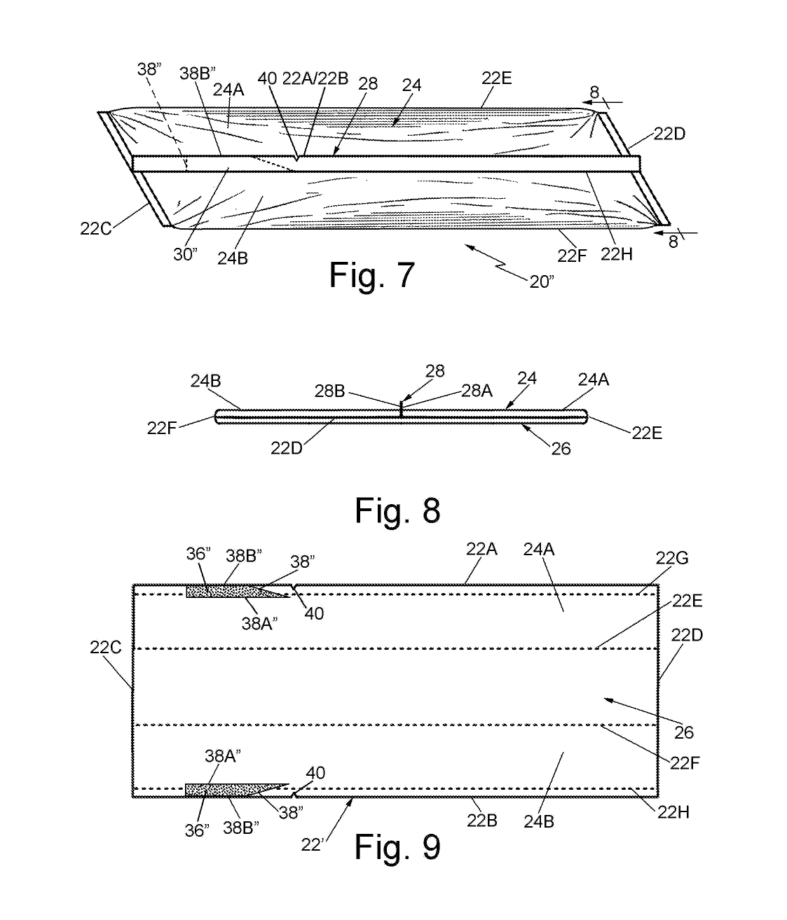

Referring now to the various figures of the drawing wherein like reference characters refer to like parts, there is shown in FIG. 1 a first exemplary embodiment of a flexible package 20 for cooking a foodstuff therein and which is constructed in accordance with this invention. Two other exemplary embodiments 20′ and 20″ are shown in FIGS. 4 and 7, respectively. The packages 20, 20′ and 20″ are merely exemplary of a myriad of packages that can be constructed in accordance with this invention. All of the packages of this invention are formed from a web or sheet 22 of any suitable flexible material which is folded up with various marginal edges sealed to form a package having an interior space in which the foodstuff to be cooked is located. Those packages also include an upstanding or projecting fin having a vent mechanism that is in communication with the interior space. The vent mechanism serves as a means for enabling egress of steam which may build up within the package as a result of the cooking of the foodstuff in the package to vent to the ambient atmosphere. The vent mechanism in the fin includes at least one vent. For example, the exemplary package 20″ makes use of a vent mechanism in the form of a single vent. The vent mechanism of the package 20′ is in the form of two vents. The vent mechanism of the package 20 is in the form of three vents. The number, placement and size of the vent(s) along the fin are important for even and thorough cooking of foodstuff in the package and will be discussed in detail later.

As can clearly be seen from FIGS. 1 and 2, the package 20 is in the form of a flat, pillow-like pouch having a longitudinally extending upstanding fin 28 that contains three evenly spaced vents: one vent in the middle of the pouch and two closer to the ends of the pouch. The even placement of vents allow evacuation of steam building up anywhere within the pouch. Moreover, the even spacing and multiple vents also allows the vents to be smaller as long as the size of the entry to each vent is adequate enough to initiate the opening of the vent. Increasing the number of vents and/or reducing the size of vent will prevent the steam pressure from opening them.

Turning now to FIGS. 3A and 3B the web or sheet of material 22 for forming the package 20 can be a single layer or ply or multiple layers or plies, any of which can be formed of a plastic material or metal foil, depending upon the oven in which the foodstuff in the package is to be cooked. For example, if the package is to be used in a microwave oven, the package should not include any metal foil, but a package for use in a conventional or convection oven may include metal foil. In accordance with one exemplary embodiment of this invention for use in a microwave oven the material forming the web or sheet 22 from which the package 20 is made is a lamination like shown in FIG. 3B and comprises an outer layer 10A formed of 48 gauge polyester, an inner sealant layer 10B formed of 150 gauge polyethylene (PE) and an intermediate adhesive layer 10C securing the outer and inner layers together. The PE sealant layer serves as the means along which various overlapping portions of the sheet 22 are welded to form the package.

The sheet 22 for forming the package 20 (as well as the packages 20′ and 20″) is of rectangular shape, although it could be of other shapes as well. Thus, for example, as can be seen in FIG. 2, the sheet 22 has a pair of long side edges 22A and 22B and a pair of short end edges 22C and 22D. The sheet 22 is arranged to be folded along two fold lines 22E and 22F to form an upper or top panel 24 and a lower or bottom panel 26 and also folded along two fold lines 22G and 22H to form the heretofore identified fin 28. In particular, the portion of the sheet 22 between the long side edge 22A and the fold line 22E is folded over at the fold line 22E so that it overlies a respective portion of the web between the fold lines 22E and 22F. That folded over portion 24A forms one section of the top panel 24. In a similar manner, the portion of the sheet 22 between the long side edge 22B and the fold line 22F is folded over at the fold line 22F so that it overlies a respective portion of the web between the fold lines 22E and 22F. That folded over portion 24B forms another section of the top panel 24.

The portion of the sheet 22 contiguous with the long side edge 22A is folded at the fold line 22G so that it projects upward from the plane of the top panel section 24A. That folded portion 28A forms one section of the fin 28. In a similar manner the portion of the sheet 22 contiguous with the long side edge 22B is folded at the fold line 22H so that it projects upward from the plane of the top panel section 24B. That folded portion 28B forms another section of the fin 28. The two sections 28A and 28B are juxtaposed so that they abut each other and are secured together, e.g., welded, along their length to form the fin 28, which projects upward from the top panel 24. In particular, upon the application of heat and pressure to the fin the polyethylene inner surfaces of those abutting sections of the fin fuse together.

The portions of the sections 24A and 24B contiguous with the side edge 22C the underlying portions of the bottom panel 26 contiguous with that side edge are secured together, e.g., welded, along their length by fusing their polyethylene inner surfaces together. In a similar manner the portions of the sections 24A and 24B contiguous with the side edge 22D the underlying portions of the bottom panel 26 contiguous with that side edge are secured together, e.g., welded, along their length by fusing their PE sealant layer inner surfaces together. The welding of those portions of the sheet produce an elongated flat, pillow-like pouch having an interior space or compartment in which the foodstuff to be cooked, e.g., an uncooked egg, is located.

As mentioned above the packages 20, 20′ and 20″ (and any other package constructed in accordance with this invention), all include a vent mechanism (single or multiple vents) to allow the egress or venting of steam from the package to the ambient atmosphere. In addition, the vent mechanism is constructed to preclude any foodstuff from passing out of the package through the vent mechanism. Further still, the vent mechanism also ensures that the integrity of the package is maintained during the cooking operation, e.g., the package does not burst upon the build-up of pressure within the package due to the formation of steam in the package.

The details of the vent mechanism of the package 20 will now be described. As mentioned above that mechanism includes three vents. In particular, the vent mechanism is composed of three vents 30, 32 and 34. Each of the vents 30, 32 and 34 is normally closed and is of identical construction. Thus, in the interest of brevity only one of those vents, i.e., vent 30, will be described in detail with reference to FIGS. 3A and 3B. Thus, as can be seen that vent basically comprises an “easy-open” heat seal coating 36 of a generally trapezoidal shape located on the inner surface of the sheet 22 contiguous with the long side edge 22A and a similarly shaped “easy-open” heat seal coating 36 located on the inner surface of the sheet 22 contiguous with the long side edge 22B. The “easy-open” coatings 36 form a barrier between the PE sealant layers 10B of the fin, so that when the fin is formed by welding the abutting marginal edge portions 22A and 22B, an openable interface or passageway 38 is created between the PE sealant layers. Each passageway 38 includes an inner end 38A located slightly inwardly of the fold line 22G, 22H (as the case may be) forming the entry of the passageway. That entry being located inward of the fold line ensures that the entry is in communication with the interior space in which the foodstuff is located. The opposite end of the passageway 38 is in the form of an outlet and terminates at the edge 22A, 22B (as the case may be) so that the outlet of the passageway is in communication with the ambient atmosphere surrounding the package 20.

The passageway 38 is configured to automatically open in response to increased pressure within the package caused by the formation of steam therein when the foodstuff is cooked. To that end, the passageway 38 is of a tapering, e.g., trapezoidal, shape. In particular, the width of the passageway at its entry 38A is larger than the width of the passageway at its outlet 38B. As should be appreciated by those skilled in the art the wider base (entry) of the trapezoidal passageway provides enough surface area to initiate the opening of the passageway due to the buildup of stream pressure in the package. The narrow top (outlet) of the trapezoidal passageway controls the opening by only allowing steam to go through it and not any portion solid and/or liquid of the cooked foodstuff.

In order to ensure that the vent mechanism (e.g., the vents 30, 32 and 34 of the pouch 20) opens properly it is of considerable importance that it is not blocked during the cooking operation. Thus, the package, e.g., the flat pouch, is designed to be disposed in the microwave oven with its bottom panel being supported on some support structure (e.g. microwave carousel), so that its fin projects or faces upward and is unobstructed, whereupon steam can freely vent out of the package via the vent mechanism during the cooking operation.

Once the foodstuff, e.g., the scrambled eggs, is cooked the end of the package 20 can be torn off to access the cooked egg product. To facilitate the opening of the package to provide access to the cooked product, the package may include a readily tearable portion. Thus, for example, the exemplary package 20 includes a V-shaped tear notch 40 located in the top edge of the fin 28 adjacent one of the ends of the package. In this exemplary embodiment the notch 40 is located in the sealed fin 28 adjacent the edge 22C, but could be located at any other desirable sealed seam on the package. In should be noted that the use other tear initiating mechanisms can be used in lieu of a V-shaped notch. Thus, it could be in the form of a slit or some frangible or otherwise weakened line in the fin or any sealed seam of the package.

In accordance with one aspect of this invention package is sized to accommodate the volume expansion of the product when it is cooked and the accumulation of steam during the cooking process. For example, the exemplary embodiment of the package 20 shown in FIGS. 1-3, for cooking a serving of scrambled eggs has a length of approximately 30 cm, a width of approximately 4-5 cm, with a volumetric capacity of approximately 360 cm², with each of the vents 30, 32 and 34 having an entry 38A width of approximately 15 mm, and an outlet 38B width of approximately 5 mm. Those sizes are merely exemplary of a myriad of sizes that the package 20 and its vent mechanism can take within the scope of this invention.

The embodiment of the package 20′ shown in FIG. 4 is similar in construction to package 20, except for the construction of its vent mechanism. Thus, in the interest of brevity the common component of the packages 20 and 20′ will be given the same reference designations and the details of the construction and operation of that package and its components will not be reiterated. The vent mechanism of the package 20′ has two vents 30′ and 32′ that are located in the fin 28 adjacent the ends of the pouch. The vents 30′ and 32′ are of identical construction, so that only one, i.e., vent 30′, will be described in detail in the interest of brevity. Since there are only two vents 30′ and 32′ in the fin of the pouch 20′ each vent has to be large enough to accommodate the steam escape rate. Further the base of each vent has to be large enough so initiate its peeling open due to the steam pressure. Thus, as can be seen in FIG. 6 the passageway 38′ of the vent 30′ is larger in size than the passageway 38 of the vent 30 of the package 20. In particular, the base or entry 38A′ to passageway 38′ is approximately 30 mm, while the outlet 38B′ of that passageway is approximately 5 mm. Those sizes are merely exemplary of a myriad of sizes that the package 20′ and its vent mechanism can take within the scope of this invention.

The embodiment of the package 20″ shown in FIG. 7 is similar in construction to packages 20 and 20′, except for the construction of the vent mechanism. Thus, in the interest of brevity the common component of the packages 20, 20′ and 20″ will be given the same reference designations and the details of the construction and operation of that package and its components will not be reiterated. The vent mechanism of the package 20″ has a single shaped vent 30″ that is located in the fin 28 adjacent one ends of the pouch. Since there is only one vent it has to be large enough to accommodate the steam escape rate. Further the base of the vent has to be large enough so initiate peeling open in response to the steam pressure. The larger trapezoidal shape also allows the steam to be held inside the pouch longer by increasing the volume inside the pouch. Additional time the steam is held in the pouch allows the product to be cooked, e.g., the eggs, to cook more evenly and thoroughly. Thus, as can be seen in FIG. 9 the passageway 38″ of the vent 30″ is larger in size than the passageway 38′ of the vent 30′ of the package 20. In particular, the base or entry 38A″ to passageway 38″ is approximately 75 mm, while the outlet 38B″ of that passageway is approximately 40 mm. Those sizes are merely exemplary of a myriad of sizes that the package 20″ and its vent mechanism can take within the scope of this invention.

As should be appreciated by those skilled in the art from the discussion above, the packages of this invention, particularly when in the form of a pillow style pouch, allow the pouch to be placed flat in a microwave oven while the fin seal with the vent(s) faces upward. This way the fin seal sits above the product and during the cooking process, so that no product exits the vent(s), only steam. Moreover, the flat pouch allows the liquid product to distribute evenly (even liquid level throughout the pouch). This helps with the even and consistent cooking. Having single large vent or multiple vents evenly along the fin seal allows all the steam to escape allowing the cooked product to be cooled off quickly. The pouch configuration can also accommodate a tear notch on the fin seal to provide easy access to the cooked product. To that end, once the product is cooked evenly and thoroughly the end user can tear off the end of the pouch to access to content within the pouch. Once the end is torn off on a single vent pouch (if the tear notch is placed right below the vent opening) there are no other openings on the fin seal of the pouch. This helps the end user from getting condensation or any uncooked portions getting on the user's hands while squeezing the contents out of the pouch. For a pouch with multiple open vents condensation and/or solids will not come out of the open vent since the fin seal gets folded over against the pouch. The width and length of the package (e.g., pouch) can be adjusted to accommodate the volume of the cooked foodstuff. In this regard, the pouch should be large enough to accommodate the volume of the cooked egg product which is more than twice the volume of the liquid, e.g., uncooked scrambled egg product.

The size of packages 20, 20′, and 20″ described above are for a single serving of foodstuff (egg). The size can be increased to accommodate multi-servings as long as it is able to fit and lay flat in a microwave oven.

Without further elaboration the foregoing will so fully illustrate my invention that others may, by applying current or future knowledge, adopt the same for use under various conditions of service.

I claim:

1. A flexible package for holding a foodstuff to be cooked therein, said package being formed of a flexible sheet material and comprising a bottom panel, a top panel, and an interior space therebetween in which the foodstuff to be cooked can be located, said top panel comprising an elongated upstanding fin having at least one vent therein, said upstanding fin being formed by edge portions of said top panel, said at least one vent comprising respective portions of said edge portions releasably secured together by a peelable interface having a first end in communication with said interior space and a second end in communication with the ambient atmosphere outside of said package, said peelable interface forming an openable passageway tapering from said first end to said second end and being configured to open in response to the production of steam within said package when the foodstuff is cooked therein, whereupon the steam can exit the package through said passageway.

2. The flexible package of claim 1 wherein the size of said passageway at said first end is sufficiently large to enable steam generated in said interior space by the cooking of the foodstuff to initiate the opening of said passageway and with the size of said passageway at said second end being sufficiently small to enable the steam to exit the package through said passageway, while preventing any of the foodstuff from exiting said package through said passageway.

3. The flexible package of claim 2 wherein said passageway is of trapezoidal shape.

4. The flexible package of claim 1 wherein said at least one vent is configured and disposed along said upstanding fin to ensure even and thorough cooking of the foodstuff within said package.

5. The flexible package of claim 2 wherein said at least one vent is configured and disposed along said upstanding fin to ensure even and thorough cooking of the foodstuff within said package.

6. The flexible package of claim 1 wherein said package comprises a flat pouch and with said bottom wall being configured to be disposed on a surface in an oven such that said upstanding fin is exposed to enable steam to readily vent through said passageway.

7. The flexible package of claim 2 wherein said package comprises a flat pouch and with said bottom wall being configured to be disposed on a surface in an oven such that said upstanding fin is exposed to enable steam to readily vent through said passageway.

8. The flexible package of claim 5 wherein said package comprises a flat pouch and with said bottom wall being configured to be disposed on a surface in an oven such that said upstanding fin is exposed to enable steam to readily vent through said passageway.

9. The flexible package of claim 1 wherein said package comprises at least two vents and wherein said vents are disposed along said upstanding fin to ensure even and thorough cooking of the foodstuff within said package.

10. The flexible package of claim 2 wherein said package comprises at least two vents and wherein said vents are disposed along said upstanding fin to ensure even and thorough cooking of the foodstuff within said package.

11. The flexible package of claim 5 wherein said package comprises at least two vents and wherein said vents are disposed along said upstanding fin to ensure even and thorough cooking of the foodstuff within said package.

12. The flexible package of claim 1 wherein said interior space is of sufficient volume to accommodate the volume of the foodstuff after it has been cooked, without any portion of the cooked foodstuff gaining accidental egress from said package.

13. The flexible package of claim 1 wherein said package includes a readily openable portion to enable access to the cooked foodstuff.

14. The flexible package of claim 1 wherein a portion of said package includes a tear-initiating notch and a portion of said package contiguous with said tear-initiating notch is tearable, such that one can tear the package open to provide access to the cooked foodstuff by pulling on said tear-initiating notch.

15. The flexible package of claim 1 wherein said bottom panel comprises a pair of side edges and a pair of end edges, said top panel comprises a first section having a pair of side edges and a pair of end edges, and a second section having a pair of side edges and a pair of end edges, one of said side edges of said first section being connected to one of said side edges of said bottom panel and the other of said side edges of said first section forming one portion of said fin, one of said side edges of said second section being connected to the other of said side edges of said bottom panel and the other of said side edges of said second section forming another portion of said fin, with respective end edges of said first section being connected to respective end edges of said bottom panel, and with respective end edges of said second section being connected to respective end edges of said bottom panel.

16. The flexible package of claim 15 wherein said at least one vent is configured and disposed along said upstanding fin to ensure even and thorough cooking of the foodstuff within said package.

17. The flexible package of claim 15 wherein said package comprises a flat pouch and with said bottom wall being configured to be disposed on a surface in an oven such that said upstanding fin is exposed to enable steam to readily vent through said passageway.

18. The flexible package of claim 16 wherein said package comprises a flat pouch and with said bottom wall being configured to be disposed on a surface in an oven such that said upstanding fin is exposed to enable steam to readily vent through said passageway.

19. The flexible package of claim 15 wherein said fin includes a tear-initiating notch and a portion of said package contiguous with said tear-initiating notch is tearable, such that one can tear the package open to provide access to the cooked foodstuff by pulling on said tear-initiating notch.

20. The flexible package of claim 16 wherein said fin includes a tear-initiating notch and a portion of said package contiguous with said tear-initiating notch is tearable, such that one can tear the package open to provide access to the cooked foodstuff by pulling on said tear-initiating notch.

21. In combination a package containing a foodstuff to be cooked therein, said package being formed of a flexible sheet material and comprising a bottom panel, a top panel, and an interior space therebetween in which said foodstuff is located, said top panel comprising an elongated upstanding fin having at least one vent therein, said upstanding fin being formed by edge portions of said top panel, said at least one vent comprising respective portions of said edge portions releasably secured together by a peelable interface having a first end in communication with said interior space and a second end in communication with the ambient atmosphere outside of said package, said peelable interface forming an openable passageway tapering from said first end to said second end and being configured to open in response to the production of steam within said package when the foodstuff is cooked therein, whereupon the steam can exit the package through said passageway.

22. The combination of claim 21 wherein the size of said passageway at said first end is sufficiently large to enable steam generated in said interior space by the cooking of said foodstuff to initiate the opening of said passageway and with the size of said passageway at said second end being sufficiently small to enable the steam to exit the package through said passageway, while preventing any of said foodstuff from exiting said package through said passageway.

23. The combination of claim 22 wherein said passageway is of trapezoidal shape.

24. The combination of claim 21 wherein said at least one vent is configured and disposed along said upstanding fin to ensure even and thorough cooking of the foodstuff within said package.

25. The combination of claim 22 wherein said at least one vent is configured and disposed along said upstanding fin to ensure even and thorough cooking of said foodstuff within said package.

26. The combination of claim 21 wherein said package comprises a flat pouch and with said bottom wall being configured to be disposed on a surface in an oven such that said upstanding fin is exposed to enable steam to readily vent through said passageway.

27. The combination of claim 22 wherein said package comprises a flat pouch and with said bottom wall being configured to be disposed on a surface in an oven such that said upstanding fin is exposed to enable steam to readily vent through said passageway.

28. The combination of claim 25 wherein said package comprises a flat pouch and with said bottom wall being configured to be disposed on a surface in an oven such that said upstanding fin is exposed to enable steam to readily vent through said passageway.

29. The combination of claim 21 wherein said package comprises at least two vents and wherein said vents are disposed along said upstanding fin to ensure even and thorough cooking of said foodstuff within said package.

30. The combination of claim 22 wherein said package comprises at least two vents and wherein said vents are disposed along said upstanding fin to ensure even and thorough cooking of said foodstuff within said package.

31. The combination of claim 25 wherein said package comprises at least two vents and wherein said vents are disposed along said upstanding fin to ensure even and thorough cooking of said foodstuff within said package.

32. The combination of claim 21 wherein said interior space is of sufficient volume to accommodate the volume of said foodstuff after it has been cooked, without any portion of the cooked foodstuff gaining accidental egress from said package.

33. The combination of claim 21 wherein said package includes a readily openable portion to enable access to the cooked foodstuff.

34. The combination of claim 21 wherein a portion of said package includes a tear-initiating notch and a portion of said package contiguous with said tear-initiating notch is tearable, such that one can tear the package open to provide access to the cooked foodstuff by pulling on said tear-initiating notch.

35. The combination of claim 21 wherein said bottom panel comprises a pair of side edges and a pair of end edges, said top panel comprises a first section having a pair of side edges and a pair of end edges, and a second section having a pair of side edges and a pair of end edges, one of said side edges of said first section being connected to one of said side edges of said bottom panel and the other of said side edges of said first section forming one portion of said fin, one of said side edges of said second section being connected to the other of said side edges of said bottom panel and the other of said side edges of said second section forming another portion of said fin, with respective end edges of said first section being connected to respective end edges of said bottom panel, and with respective end edges of said second section being connected to respective end edges of said bottom panel.

36. The combination of claim 35 wherein said at least one vent is configured and disposed along said upstanding fin to ensure even and thorough cooking of said foodstuff within said package.

37. The combination of claim 35 wherein said package comprises a flat pouch and with said bottom wall being configured to be disposed on a surface in an oven such that said upstanding fin is exposed to enable steam to readily vent through said passageway.

38. The combination of claim 36 wherein said package comprises a flat pouch and with said bottom wall being configured to be disposed on a surface in an oven such that said upstanding fin is exposed to enable steam to readily vent through said passageway.

39. The combination of claim 35 wherein said fin includes a tear-initiating notch and a portion of said package contiguous with said tear-initiating notch is tearable, such that one can tear the package open to provide access to the cooked foodstuff by pulling on said tear-initiating notch.

40. The combination of claim 21 wherein said foodstuff comprises an uncooked egg.
